(19) United States
(12) Patent Application Publication
(10) Pub. No.: US 2022/0059898 A1
(43) Pub. Date: Feb. 24, 2022

(54) BATTERY PACK ASSEMBLY

(71) Applicant: Aceleron Limited, Birmingham, West Midlands (GB)

(72) Inventors: Amrit CHANDAN, Birmingham, West Midlands (GB); Carlton CUMMINS, Birmingham, West Midlands (GB)

(21) Appl. No.: 17/415,350

(22) PCT Filed: Dec. 23, 2019
(86) PCT No.: PCT/GB2019/053690

§ 371 Date: Jun. 17, 2021

(30) Foreign Application Priority Data
Dec. 21, 2018 (GB) 1821083.1

(51) Int. Cl. H01M 50/213; H01M 50/262; H01M 50/271; H01M 50/296; H01M 50/502; H01M 50/574

(52) U.S. Cl. CPC H01M 50/213; H01M 50/262; H01M 50/574; H01M 50/296; H01M 50/502; H01M 50/271

(57) ABSTRACT

A battery pack assembly (1) comprises a first holding frame (10A) and a second holding frame (10B) for holding a plurality of cells (15A, 15B . . . 15Z) therebetween, a conductor (11A) for engaging the plurality of cells (15A, 15B . . . 15Z) and having at least a first contact (17A) for engaging a first cell terminal (TA) and a second contact (17B) for engaging a second cell terminal (TB), a resilient member (13A) being located between the conductor (11A) and one of the first or second holding frame (10A, 10B) to bear against the conductor (11A) adjacent the first contact (TA) and second contact (TB).

This invention relates generally to a battery pack assembly. More specifically, although not exclusively, this invention relates to a lithium-ion battery pack assembly, for example, a large format battery pack assembly, methods of making the same, and uses of the same.

Lithium-ion batteries are known in a variety of cell formats, cylindrical, prismatic and pouch cells are the most common varieties. In a cylindrical cell the electrode is tightly wound about itself and the terminals are typically found at either end of the cylinder, the electrode being contained within a casing, typically made from aluminium or steel. Due to the shape of the cell packing efficiency may be low but the provision of spaces between adjacent cells is useful for thermal management purposes. The electrodes of prismatic cells can be wound, stacked or folded and are usually located within an aluminium or plastics housing. The terminals are often on one end of the cell which, coupled with the shape of the cell improves packing efficiency. Pouch cells typically have stacked or folded electrodes encased in a flexible plastics casing. The terminals of pouch cells may extend from different sides of the pouch but conveniently they may both extend from one side, for example the top, of the pouch.

It is known to connect lithium-ion batteries or cells in series to increase the voltage to produce a “large format battery pack”. These offer several benefits including high energy density in comparison to their weight, high operating voltage and slow self-discharge. Consequently, large format battery packs of this type find use in a range of both consumer and industrial applications including as emergency power back-up, vehicle power, and solar power storage.

There appears to be no set definition of what constitutes a “large format battery pack”. The UN, for example (e.g. in relation to the UN38.3 Procedure), states that a ‘large battery’ is one that has a mass in excess of 12 kg whereas some manufacturers specify that large batteries or large format battery packs have an energy storage in excess of 1 kWh. For the purposes of this invention we consider that a large format battery pack is one with more than three cells (be they cylindrical, prismatic or pouch) connected in series.

Large format battery packs using cylindrical cells often have a plurality of cells, typically 15 or more cells, electrically connected and presented as a single unit called a battery module. In industry, these modules are typically assembled using permanent assembly techniques (structural adhesives, spot welding, soldering etc.). Such permanent assembly techniques present challenges for repairing or reusing the modules (or the cells or other parts thereof), as the individual components of the assembly cannot easily be accessed or removed. This also makes it difficult to recycle the modules, as the various materials cannot easily be separated.

Accordingly, such production techniques can lead to energy storage products which are not aligned with EU waste management legislations and prohibits greater revenue opportunities in the repair and repurposing of batteries and battery modules.

It is therefore a first non-exclusive object of the invention to provide a large format battery pack assembly that is configured such that the components can be more readily recycled.

Accordingly, a first aspect of the invention provides a battery pack assembly comprising a first and second holding frame for holding a plurality of cells therebetween, a conductor for engaging the plurality of cells and having at least a first contact for engaging a first cell terminal and a second contact for engaging a second cell terminal, and a resilient member, the resilient member being located between the conductor and one of the first or second holding frame to bear against the conductor at a position adjacent the first contact and the second contact.

In the battery pack assembly, the conductor is located between the resilient member and the cell terminals of said plurality of cells. The conductor comprises a first major surface for engaging the first, second, . . . n^{th} cell terminal, and a second major surface against which the resilient member bears. By the term ‘adjacent’, we mean that the respective contact on the first major surface of the conductor is in engagement with respective cell terminal and that the resilient member bears against the second major surface of the conductor in a corresponding position.

In embodiments, the battery pack assembly comprises a first resilient member located between a first conductor and the first holding frame, and a second resilient member located between a second conductor and the second holding frame.

The conductor preferably connects three or more cell terminals in parallel or series. Preferably, the arrangement of the conductor in each of the two holding frames is complementary, such that the conductors and cells together form a complete circuit when the plurality of cells are held within the two holding frames, electrically connecting all of the cells in the assembly in parallel and/or series. For example, the cells may be arranged with neighbouring cells alternatively positioned with the positive terminal upwards and the positive terminal downwards respectively, and the positive and negative terminals on each side being connected together, so that a complete circuit is formed.

The conductor may comprise one or more conductive plates. In embodiments, a first and/or second conductor may comprise two or more, e.g. three, four, five, or n conductive plates (where ‘n’ is a positive integer). For example, the conductor may comprise a first one or more conductive plate(s) associated with the first holding frame and a first resilient member, and a second one or more conductive plate(s) associated with the second holding frame and second resilient member. The conductive plates may be any shape which would cover more than one cell terminal, such as a rectangular, U-shaped, S-shaped, L-shaped, T-shaped, H-shaped, and so on.

The resilient member may bear against plural conductive plates of the conductor. In an embodiment the resilient member may bear against most or all of the conductive plates of the conductor.

In embodiments, the first contact of the conductor for engaging a first cell terminal and/or the second contact of the conductor for engaging a second cell terminal, is provided by a protrusion. The first contact may comprise a protrusion on a first major surface of the conductor. The first contact may comprise a rebate on a second major surface of the conductor. The rebate may correspond with the protrusion. There may be provided ‘n’ contacts for engagement with respective ‘n’ cell terminals. For example, a contact, e.g. a protrusion, may be provided on the conductor for engaging an nth cell terminal. A contact, e.g. a protrusion, may be provided on the conductor to engage each cell terminal of the plurality of cells located within the battery pack assembly such that one contact, e.g. protrusion, is provided per cell terminal. The conductor will be oriented such that the protrusion will typically be directed towards the cell terminal.

In embodiments, the conductor may be fabricated from conductive plastics material or from one or more metal sheets. The protrusions may be fabricated, for example, by stamping a metal sheet, which forms the conductive means, e.g. a conductive plate. The one or more conductor(s) may be fabricated from aluminium or steel, e.g. aluminium sheet. The metal sheet, e.g. aluminium sheet, may be between 0.1 to 1.0 mm in thickness, e.g. from any one of 0.1, 0.2, 0.3, 0.4, 0.5, 0.6, 0.7, 0.8, 0.9 mm to any one of 1.0, 0.9, 0.8, 0.7, 0.6, 0.5, 0.4, 0.3, or 0.2 mm in thickness. Preferably, the metal sheet, e.g. aluminium sheet, is between 0.6 to 1.0 mm in thickness, e.g. between 0.7 to 0.9 mm thick, or 0.8 mm thick.

The protrusions may be fabricated, for example, by stamping a metal sheet, which forms the conductor plate. Advantageously, the protrusions aid electrical contact to be made between the conductor plate, e.g. one or more conductive plates, and the cell terminals. One or more (e.g. each) of the protrusions will extend from the first major surface of the conductor plate. The second major surface may have a corresponding depression. This is advantageously achieved by stamping from a thin conductive material, e.g. a metal sheet. In embodiments, the protrusions extend from 0.1 to 0.3 mm above the plane of the conductor plate, e.g. 0.1 to 0.2 mm or 0.2 to 0.3 mm.

Advantageously, the protrusions aid electrical contact to be made between the conductor, e.g. one or more conductive plates, and the cell terminals. One or more (e.g. each) of the protrusions will extend from the first major surface of the conductor. The second major surface may have a corresponding depression. This is advantageously achieved by stamping from a thin conductive material, e.g. a metal sheet.

The cell assembly may be readily assembled and/or disassembled. That is, the cell assembly may be readily demountable into its component parts such that the plurality of cells can be readily removed. The cell assembly may comprise fastening means. The first and second holding frames are preferably reversibly held with respect to one another in a closed condition by a fastening means or fastener. The fastening means or fastener causes terminals of the two cells to be urged against the conductor (and/or vice versa) and removal or loosening of the fastener or fastening means enables the cells to be freed from the assembly.

Advantageously, in embodiments, the battery pack assembly does not comprise any “permanent” fastening means, e.g. adhesive. The fastening means may be reversible such that the plurality of cells are readily removed from the battery pack assembly without causing damage to any of the components of the battery pack assembly.

In a closed condition of the battery pack assembly, the protrusions of the conductor extend towards the cell terminals. The portion of the resilient member adjacent the protrusion of the conductor is preferably urged to extend into the corresponding depression, where present, of the conductor, e.g. by fastening said fastening means or fastener. The resilience of the resilient member provides effective or intimate electrical contact between the conductor, for example a respective protrusion, and the cell terminals, when the battery pack assembly is in use.

One or more or each conductor, e.g. one or more or each conductive plate, may further comprise an electrical terminus to connect the appropriate conductor or conductor, e.g. conductive plate, to external means, e.g. an external circuit, to use the electrical power.

The resilient member may be a unitary body. The resilient member may comprise a sheet. The resilient member may comprise one or more resilient sheets associated with a holding frame of the battery pack assembly. In embodiments, the resilient member may comprise two or more, e.g. three, four, five, resilient sheets. The resilient member may be seated within one or more of the holding frames. The resilient member may be sized to extend to one or more internal edges, and/or to the inner perimeter of a holding frame. Alternatively, the resilient member may be sized to have a smaller major surface than that of a holding frame.

In embodiments, the resilient member may comprise or consist of one or more sheets of resilient material, for example, a polymeric or elastomeric material. The resilient member may be fabricated from a rubber material. In an embodiment the resilient member may be fabricated from, or comprise, a silicone-based material, e.g. silicone rubber. In an embodiment the resilient material may be fabricated from ethylene-propylene-diene rubber, hydrogenated nitrile butadiene rubber or other rubbers. The resilient member may be formed from an expanded polymeric material, for example expanded polystyrene. The resilient member will have sufficient heat resistant properties to withstand typical battery operating temperatures.

Advantageously, the resilient member acts to encourage electrical contact between the first, second, or n^{th} contacts of the conductor for engagement with one or more cell terminals. For example, a portion of the resilient member may be forced into the depression corresponding to the protrusion of the conductor, when the assembly is under compression, e.g. from the fastening of the fastening means or fastener. This ensures intimate electrical contacts are maintained even when the assembly undergoes vibration.

In addition, the provision of a resilient member, for example a resilient member formed as a unitary body, e.g. that extends to one or more internal edges of the holding frame, provides enhanced and uniform electrical contact between the cell terminals and the conductor. The provision of a single resilient member ensures ease of manufacture. Moreover, a unitary body is easily manufactured and/or replaced if and when the component wears out to enable greater recyclability of the components of the assembly.

In embodiments wherein the first contact comprises a rebate or one or more rebates, for example where the first contact comprises a protrusion on a first major surface of the conductor and a corresponding rebate on a second major surface of the conductor, the resilient member may extend into one or more rebates, for example the one or more rebates on the second major surface of the conductor.

The first and/or second holding frame may comprise one or more locating members. The resilient member may comprise one or more cooperating members. The locating members and the cooperating members cooperating to ensure that the resilient member is appropriately located or locatable with respect to the holding frame. In an embodiment, the first and/or second holding frame may comprise, e.g. as a locating member, a formation and the resilient member may comprise a corresponding portion. In an embodiment, the first and/or second holding frame comprises, e.g. as a locating member, one or more spigots and the resilient member comprises one or more corresponding apertures. Advantageously, the first and/or second holding frames has plural locating members. The said plural locating members may cooperate to provide one or more cell locating structures. The cell locating structures provide regions of the first and/or second holding frame in which cells are located or locatable.

The resilient member may comprise or consist of a sheet comprising apertures. Each aperture may correspond to a respective locating member, e.g. a respective formation.

In embodiments, the locating members may together define a plurality of whole or part generally cylindrical regions, each defined by a concave arcuate, e.g. side wall, section and at least one concave arcuate base protrusion wall section, wherein each generally cylindrical region may seat a cylindrical cell.

The conductor may comprise one or more conductor cooperating members, the conductor cooperating members preferably being arranged to cooperate with the locating members of the first and/or second holding frame.

The first contact and the second contact may be located between said conductor cooperating members. The conductor cooperating members may describe a conductor cooperating member array. The first and second (e.g. and nth) contact may form a contact array. The contact array and the conductor cooperating member array may be displaced with respect to one another, such that a contact does not overlie a conductor cooperating member.

The fastening means or fastener may be any suitable reversible fastening means known to the skilled person. For example, the fastening means may comprise or may consist of a plurality of fastening nuts and/or bolts. Each fastening bolt may each thread through a hole in each of the two holding frames and act to compress the assembly, encouraging contact between the cells and the conductor.

In embodiments, the battery pack assembly consists of a set of cells positioned between two parallel holding frames, each cell being held longitudinally between the two holding frames by virtue of the fastening means being fastened, secured or ‘tightened’ to clamp the cells between the holding frames.

Advantageously, in an assembled or closed configuration, the fastening means cause the at least first and second contacts of the conductor to be urged into contact with the two or more cell terminals. The fastening means may be loosened or removed in a disassembled or open configuration to enable the plurality of cells to be freed from the battery pack assembly.

This allows for the complete disassembly of a large format battery pack assembly into its individual components. The ability to completely disassemble the assembly permits the module to be repaired via the replacement of individual cells or other components, allows individual components of the module to be reused for further applications at the end of the useful life of the complete assembly, and allows for improved recycling as each of the individual components of the module can be separated and sorted for recycling accordingly. Further, it also allows for upgrades or replacement of components as may be required over the service life of the assembly. The use of, preferably, a single resilient member having cooperating members eases fabrication and reduces fabricating time. Moreover, the use of, preferably, a single resilient member means that end-of-life recycling is made easier.

As well as assisting manufacturers to meet EU waste management legislation, the ability to reuse, repair and recycle individual components of battery modules would also save money and resources for the manufacturers. Individual or multiple cells may be replaced with ease, meaning the assemblies could be repeatedly rebuilt at end of life instead of being disposed. It also presents the opportunity for the reuse of cells from a module in other energy storage applications when they no longer perform in the original module application or when the module is no longer required.

One of the holding frames may be or may provide an access lid, which can be opened or removed to gain access to the cells.

The two or more holding frames may be shaped to accommodate cylindrical cells and/or cells of different shapes other than cylindrical ones, e.g. rectangular or other shapes.

In embodiments, one or more, or each, holding frame may comprise a generally flat base and one or more side walls, e.g. upstanding side walls. In embodiments, one or more or each holding frame may comprise a side wall which upstands from the periphery of the base of the one or more, or each, holding frame. In embodiments, one or more or each holding frame may comprise an upstanding side wall which extends around the entire periphery of the base of the one or more, or each, holding frame. In alternative embodiments, the upstanding side wall may extend around a portion of the periphery of the base of the one or more, or each, holding frame. In an embodiment the side wall may be discontinuous. In embodiments in which the holding frame is to be used with cylindrical cells, at least one side wall, and preferably facing side walls, may further comprise a one or more concave arcuate sections complementary to the side wall of the cells to be inserted into the assembly.

In embodiments, one or more of the holding frames (e.g. each holding frame) may be configured or shaped to encase the ends of one or more cells, in use. For example, one or more (e.g. each) holding frame may encase a respective end of each cell, in use. In embodiments, one or more of the holding frames (for example, each holding frame) may encase one or more cell terminal(s), e.g. each cell terminal. In an embodiment one or more of the holding frames may comprise cooperating portions inboard of the periphery thereof. The cooperating portions may be shaped to cooperate with and/or correspond to the external periphery of at least a portion of one or more cells.

Advantageously, provision of an upstanding side wall and/or encasing one or more ends or terminals of the cells, in use, provides a more secure battery pack assembly with respect to the plurality of cells. This provides better contact between the conductor and the cell terminals, which is further enhanced by the resilient member, which is located between the conductor and one or more of the holding frames. This is particularly advantageous when no permanent fastening means (e.g. adhesive) are provided within the battery pack assembly, such that the assembly is rigid and stable in use, but may be readily disassembled into its component parts.

In alternative embodiments, each holding frame may comprise a base portion with no side walls.

The holding frames may comprise a plurality of protrusions extending from the base, e.g. perpendicularly from the base, for example to delimit or space adjacent portions of the cells from one another. For example, the walls of the base protrusions may comprise a plurality of shaped sections, e.g. concave arcuate sections, complementary to the facing portions of the cells to be inserted into the assembly.

In embodiments, the battery pack assembly may comprise an n^{th} and/or an intermediate holding frame. In these embodiments, the battery pack assembly comprises a first plurality of cells located between the first outer holding frame and the n^{th} and/or intermediate holding frame, and a second plurality of cells located between the n^{th} and/or intermediate holding frame, and a second outer holding frame.

In embodiments, the holding frame (F)-cell (C)-holding frame (F) (i.e. FCF) architecture can be repeated plural times to form an FCFCF architecture, or FCFCF . . . CF architecture, that is, there may be more than two holding frames, e.g. a first outer holding frame and an intermediate holding frame between which a first plurality of cells is located, and a second outer holding frame, wherein a second plurality of cells is located between the second outer holding frame and the intermediate holding frame. In embodiments, there may be more than one intermediate holding frame, for example, two, three or more intermediate holding frames situated between the first and second outer holding frames, with a plurality of cells situated between each holding frame.

In such a case the ‘end’ frames, being those at the terminal edges of the battery pack, may have portions to receive the facing cell or cells whereas the ‘intermediate’ frames, being those between the end frames, may have a first side having portions to receive the facing cell or cells and a second side having portions to receive the facing cell or cells.

The two or more holding frames may be fabricated from an electrically insulative material, for example, a polymer or plastic material. The two or more holding frames may be fabricated using any suitable method, e.g. injection moulding of a suitable material. Suitable materials for fabricating the holding frames include Nylon, PPE (polyphenylene ether), ABS (acrylonitrile butadiene styrene), PA (polyamide), PP (polypropylene), PS (polystyrene). Each holding frame may be any suitable thickness, e.g. above 1 mm thick, to withstand the compressive force applied by a or the fastening means or fastener.

In embodiments, the battery pack assembly comprises one or more conduction breaking means or conduction breaker. A conduction breaking means or conduction breaker may be positioned between each cell terminal, and the conductor or conductor, which may be a conductive plate. Preferably, a conduction breaking means or conduction breaker is provided between every cell terminal and the associated conductor or conductor. The purpose of the one or more conduction breaking means of conduction breaker is to break the electrical circuit between a cell and the conductor or conductor, when said cell exceeds a prescribed electrical and/or thermal limit. Upon exceeding a prescribed electrical and/or thermal limit, the conduction breaking means of conduction breaker severs the connection of the failed cell, i.e. a cell that has exceeded a prescribed electrical and/or thermal limit, isolating said failed cell from the rest of the battery pack assembly.

The conduction breaking means or conduction breaker may comprise a first conductive portion for making contact with the cell terminal, a second conductive portion for making contact with the conductor or conductor, an insulating portion, and a conduction breaker portion. The conduction breaking means or conduction breaker may comprise a metallic alloy, or a multi-metallic element and may comprise a bimetal fuse. The conduction breaker portion may comprise a low melting material, for example, a metal such as silver, or silver-plated copper, tin, or zinc, or alloys of the same, which melts upon exceeding the electrical and/or thermal limit determined by the melting point of the material.

Advantageously, the contact between the conduction breaking means or conduction breaker with both the conductor one on major surface, and the cell terminal on the opposite major surface, is increased upon ‘tightening’ of the fastening means when the battery pack assembly is under compression. More advantageously, the one or more conduction breaking means or conduction breaker allow the battery pack assembly to continue to function upon failure of an individual cell, by isolating the one or more failed cells from the other functioning cells in the battery pack assembly.

In embodiments, the battery pack assembly comprises a monitoring means or monitor for monitoring the status of each cell. The monitoring means may comprise an integrated electrical circuit, which monitors the status of each cell by detecting the number of triggered conduction breaking means or conduction breakers resulting from failed cells, i.e. a cell that has exceeded a prescribed electrical and/or thermal limit, within the battery pack assembly. The monitoring means may comprise a method of determining the condition of the battery pack assembly. For example, the monitoring means may transmit data, which has been collected about the status of each cell within the assembly, to be fed through an algorithm to compare with the optimal function of the assembly, to determine the number of fully functioning cells and the number of failed cells. Advantageously, this provides information on the overall condition and remaining useful life of the battery pack assembly.

More advantageously, this information may be used to inform the user of maintenance requirements, and of potential safety hazards from using an under-performing battery pack assembly.

The battery pack assembly may be any format including laminates, pouch, cylindrical, and/or prismatic.

The design of the assembly also allows for the integration of liquid cooling for high power applications.

The battery pack assembly of the invention may be readily demountable and/or separable into its constituent parts, thereby allowing for the replacement or maintenance of one or more of the cells within the battery pack assembly.

A further aspect of the invention provides a method for assembling a battery pack assembly, the method comprising providing a first holding frame and a second holding frame for location of a plurality of cells therebetween, locating a first conductor between the first holding frame and the plurality of cells, the first conductor comprising at least a first contact for engaging a first cell terminal and a second contact for engaging a second cell terminal, and locating a second conductor between the second holding frame and the plurality of cells, locating a resilient member between the conductor and one of the first or second holding frame to bear against the conductor adjacent the first contact and second contact.

The method may further comprise providing a third holding frame and locating a second plurality of cells between the second holding frame and the third holding frame.

The method may further comprise locating a third conductor between the second holding frame and the second plurality of cells. The method may further comprise locating a fourth conductor between the second holding frame and the second plurality of cells.

The battery pack assembly of the invention may be used as a static power source for use to power equipment that requires electricity in the home, office or workspace, or as a movable power source, e.g. for vehicles, for example, electric vehicles. The battery pack assembly may be used as a store for renewable energy, for example when coupled with a renewable energy generator, such as, for example, a solar, wind, tidal energy generator.

In an embodiment, the battery pack assembly has a mass in excess of 12 kg and/or an energy storage of 1 kWh or greater. In an embodiment the battery pack assembly is a large format battery pack.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

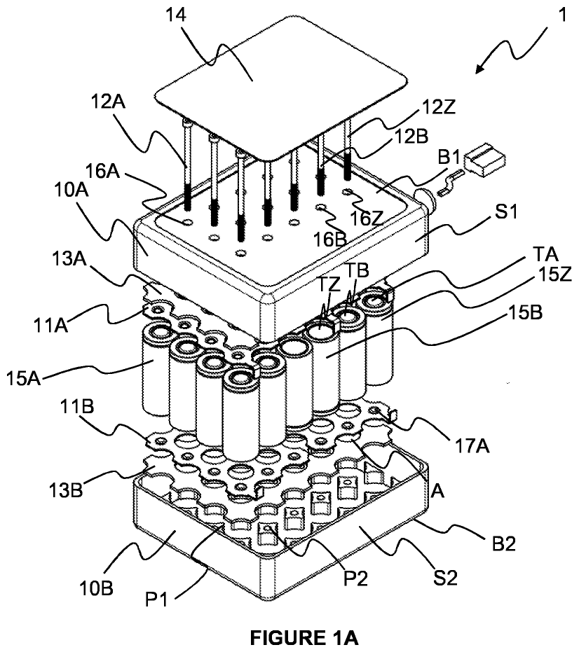

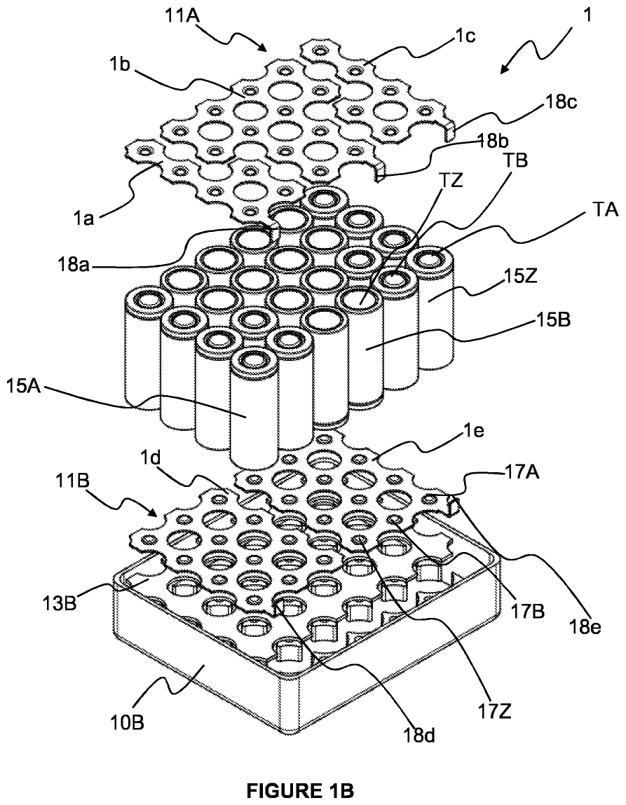

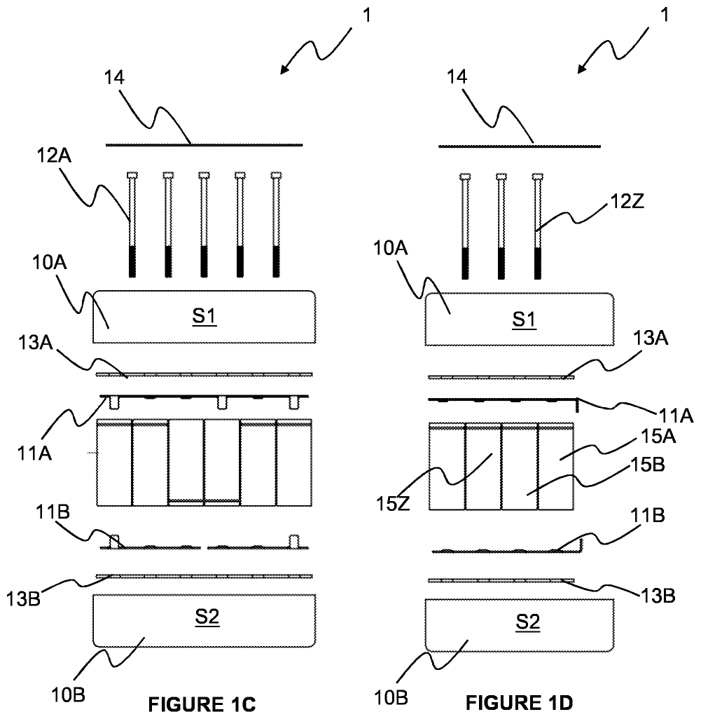

FIGS. 1A to 1D are exploded views of a battery pack assembly according to the first embodiment of the invention;

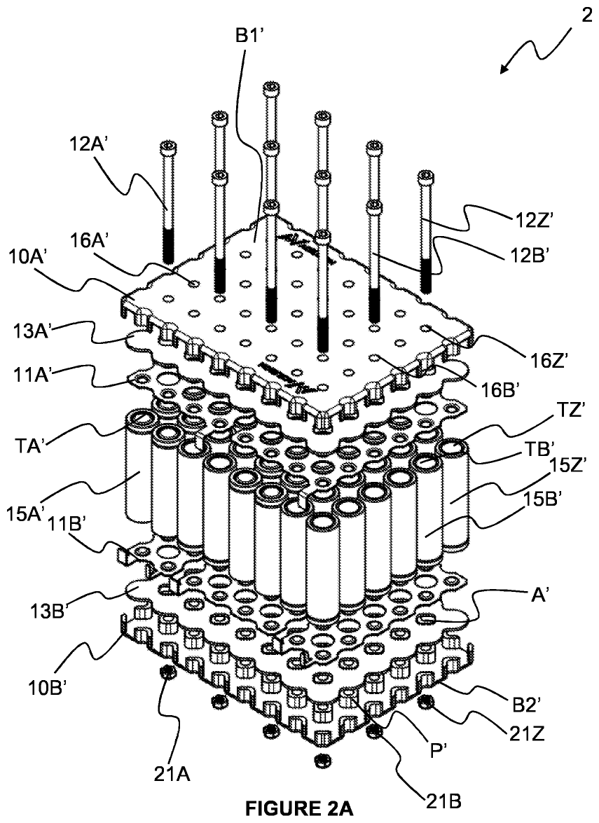

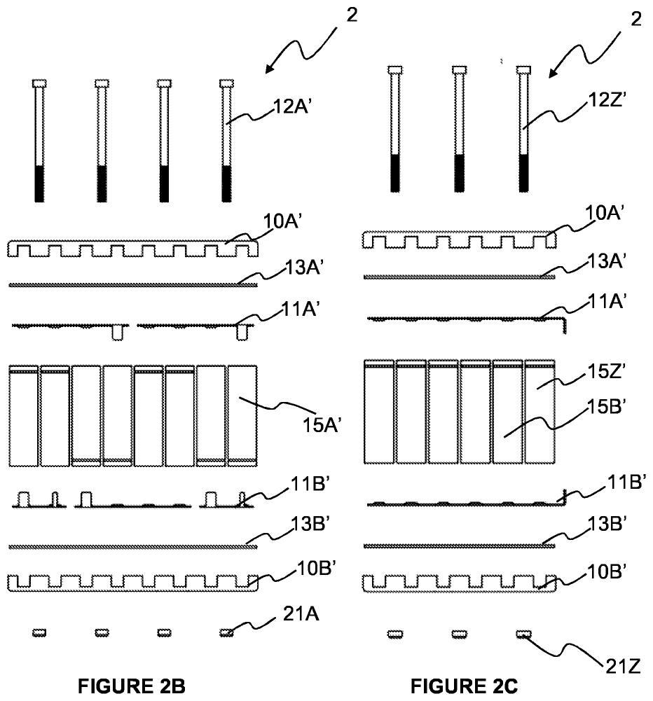

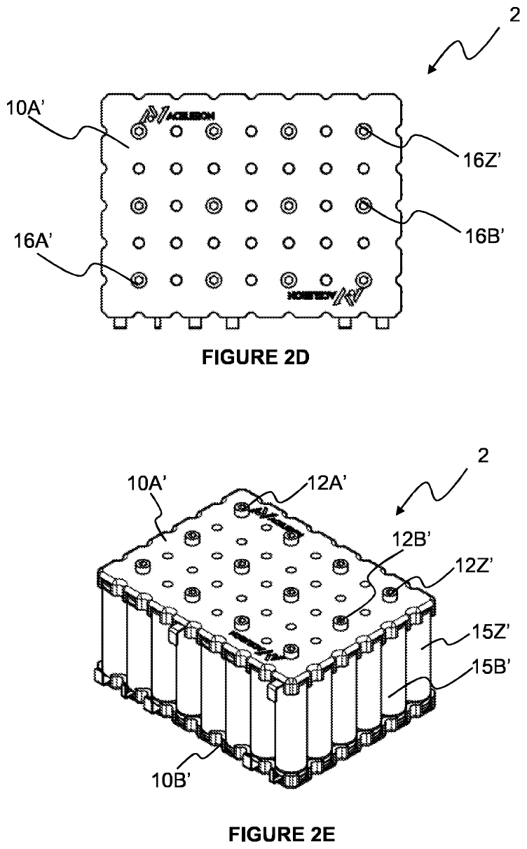

FIG. 2A to 2C are exploded views of a battery pack assembly according to the second embodiment of the invention;

FIG. 2D is a plan view of a battery pack assembly according to the second embodiment of the invention;

FIG. 2E is the battery pack assembly according to the second embodiment of the invention in an assembled or closed condition;

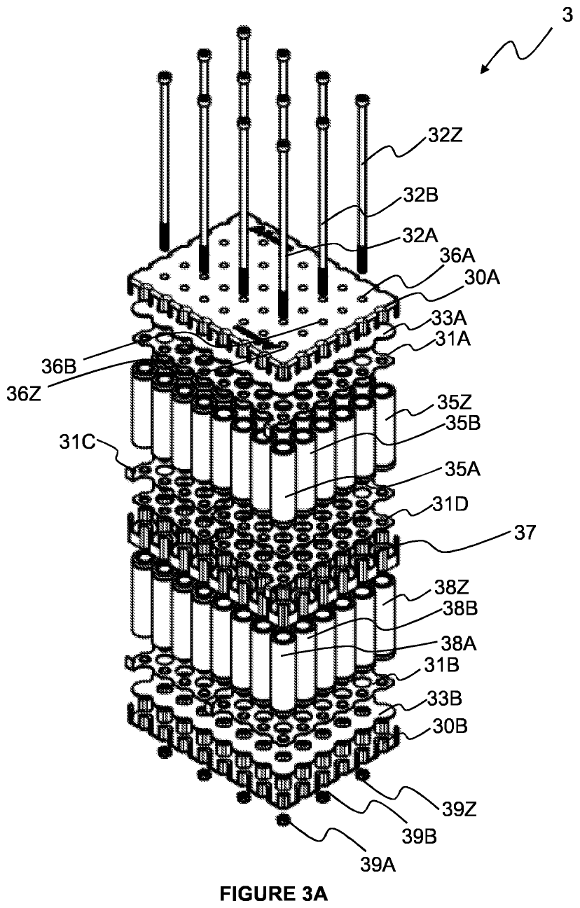

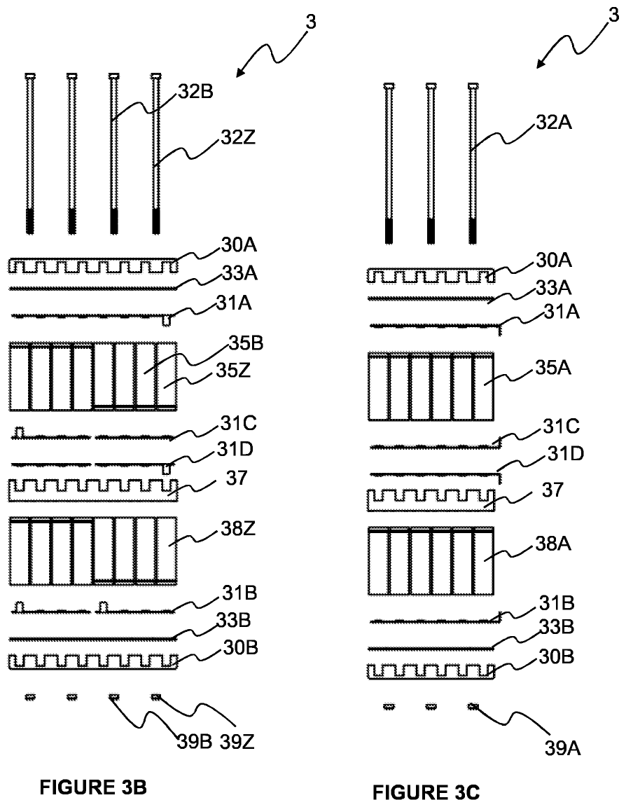

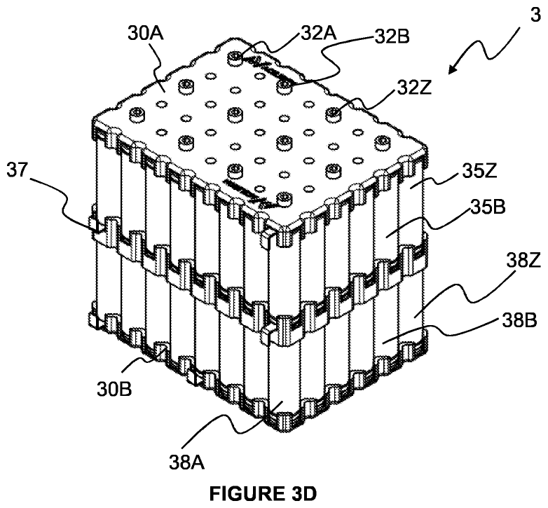

FIG. 3A to 3C are exploded views of a battery pack assembly according to the third embodiment of the invention;

FIG. 3D is a plan view of a battery pack assembly according to the third embodiment of the invention;

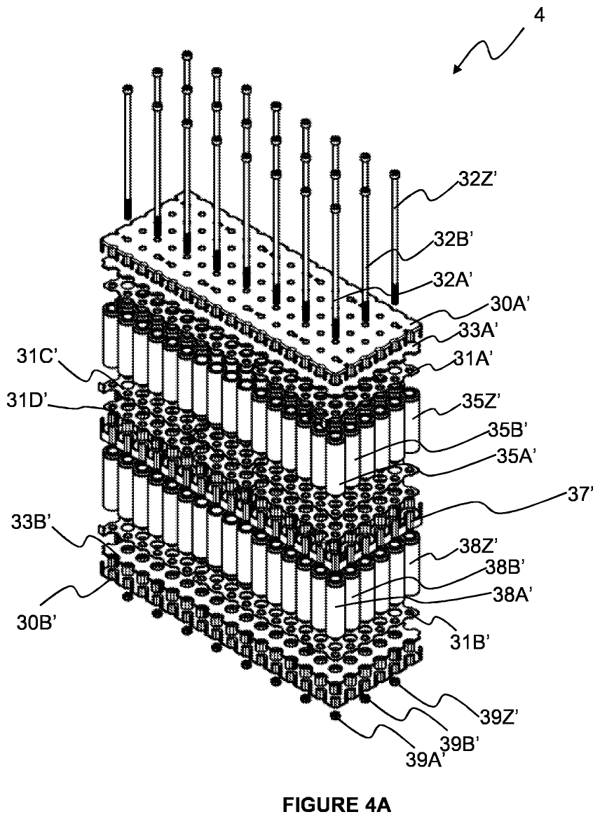

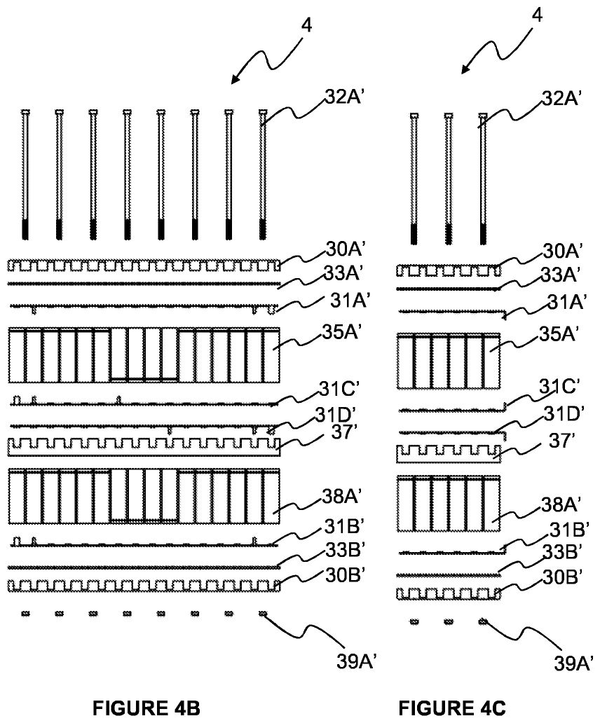

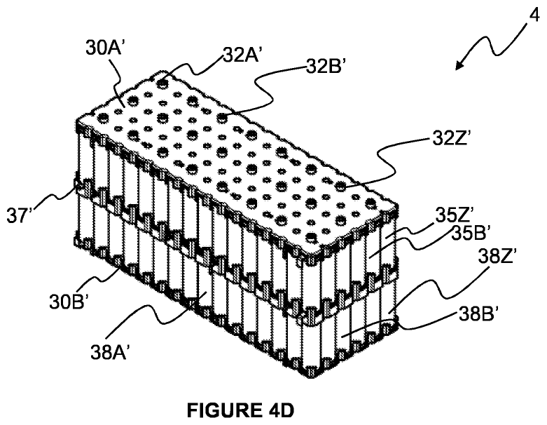

FIG. 4A to 4C are exploded views of a battery pack assembly according to the fourth embodiment of the invention; and

FIG. 4D is a plan view of a battery pack assembly according to the fourth embodiment of the invention.

Referring now to FIGS. 1A to 1D, there is shown a battery pack assembly 1 according to the first embodiment of the invention. The battery pack assembly 1 comprises a first holding frame 10A, a second holding frame 10B, a first conductor 11A, a second conductor 11B, a plurality of fasteners 12A, 12B, . . . 12Z, a first resilient member 13A, and a second resilient member 13B and a plurality of cells 15A, 15B, . . . 15Z (a 6×4 array is shown in this embodiment).

In this embodiment, the first holding frame 10A comprises a lid 14. The second holding frame 10B may optionally also comprise a lid.

The battery pack assembly 1 is configured in use to hold a plurality of cells 15A, 15B, . . . 15Z between the first holding frame 10A and the second holding frame 10B. In this embodiment, the battery pack assembly 1 is configured to hold twenty-four cells, e.g. lithium ion batteries. For convenience, only three cells are labeled in FIG. 1A. In this embodiment, the plurality of cells 15A, 15B, . . . 15Z are cylindrical in shape although the battery pack assembly 1 may also be configured to hold cells of a different shape.

The first holding frame 10A and the second holding frame 10B are each generally rectangular, and each comprise a flat base B1, B2, and a peripheral side wall S1, S2 respectively. The side walls S1, S2 upstand from the periphery of the base B1, B2 of the first and second holding frame 10A, 10B respectively to form an enclosure that is open to receive the respective terminals of the plurality of cells 15A, 15B, . . . 15Z.

The plurality of cells 15A, 15B, . . . 15Z are held longitudinally between the first holding frame 10A and the second holding frame 10B when the battery pack assembly 1 is in an assembled configuration. In this embodiment, each base B1, B2 of the first and second holding frame 10A, 10B comprises a plurality of concave arcuate side wall sections, e.g. P1 and a plurality of base protrusions, e.g. P2, that provide cell locating structures between which portions of each cell 15A, 15B, . . . 15Z are received.

The first holding frame 10A further comprises slots 16A, 16B, . . . 16Z for receiving the fasteners 12A, 12B, . . . 12Z. In this embodiment, the fasteners 12A, 12B, . . . 12Z are bolts, fifteen bolts being provided. Although the number is not critical, if the number of cells is C×R, the number of bolts is preferably (C-1)×(R-1). The slots 16A, 16B, . . . 16Z are configured to receive the fasteners 12A, 12B, . . . 12Z and as such, in this embodiment, there are fifteen slots provided.

The second holding frame 10B also comprises slots (not shown) for receiving the fasteners 12A, 12B, . . . 12Z such that each fastener, for example 12A, is inserted into the slot 16A of the first holding frame 10A and is received within a corresponding slot (not shown) in the second holding frame 10B. The fasteners 12A, 12B, . . . 12Z are secured in place, e.g. by nuts.

The first conductor 11A and the second conductor 11B are located in the battery pack assembly 1 to connect at least two of the plurality of cells 15A, 15B, . . . 15Z. The first conductor 11A is positioned between the first resilient member 13A and the terminals at the first end TA, TB, . . . TZ of each of the plurality of cells 15A, 15B, . . . 15Z. In a like manner, the second conductor 11B is positioned between the second resilient member 13B and the second terminals (not shown) of the plurality of cells 15A, 15B, . . . 15Z.

In this embodiment, and as best shown in FIG. 1B, the first conductor 11A comprises three individual conductive plates 1a, 1b, 1c, and the second conductor 11B comprises two individual conductive plates 1d, 1e. Each conductive plate 1a, 1b, 1c, 1d, 1e comprises a terminal 18a, 18b, 18c, 18d, 18e for connection to external means for use of the electrical power generated by the battery pack assembly.

The conductive plates 1a, 1b, 1c, 1d, 1e comprise plural protrusions, e.g. 17A, 17B, . . . 17Z shown for the conducive plate 1e. There is provided one protrusion per cell terminal such that the conductive plates 1a to 1e are in electrical contact with each cell terminal via a protrusion.

In an assembled configuration, the holding plate 10A is positioned adjacent the resilient member 13A, and the conductive plates 1a, 1b, 1c are positioned between the resilient member 13A and the first cell terminals TA, TB, . . . TZ at the first end of the battery pack assembly 1. In this embodiment, the conductive plate 1a extends across six cell terminals of the cells 15A, the conductive plate 1b extends across a further twelve cell terminals of the cells 15B, the conductive plate 1c extends across a further six cell terminals of the cells 15Z.

Similarly, in an assembled configuration, the holding plate 10B is positioned adjacent the resilient member 13B, and the conductive plates 1d, 1e are positioned between the resilient member 13B and the second cell terminals (not shown) at the second end of the battery pack assembly 1. In this embodiment, the conductive plate 1d extends across twelve cell terminals of each of the cells 15A and half of the cells 15B, and the conductive plate 1e extends across a further twelve cell terminals of the remaining half of cells 15B and each of the cells 15Z.

In this way, the twenty-four cells 15A, 15B, . . . 15Z are connected in series.

In this embodiment, the first and second conductor 11A, 11B, and the first and second resilient members 13A, 13B each comprise apertures, e.g. A. The apertures, e.g. A are located in areas that are not in contact with the cell terminals, e.g. TA, TB, . . . TZ when the battery pack assembly 1 is assembled and correspond and cooperate with the cell locating structures.

In use, the fasteners 12A, 12B, . . . 12Z are received in the slots 16A, 16B, . . . 16Z, and are configured using compressive forces to reversibly hold the first holding frame 10A and the second holding frame 10B with respect to one another in a closed or assembled condition.

In the closed or assembled condition, the fasteners 12A, 12B, . . . 12Z cause terminals of the plurality of cells 15A, 15B, . . . 15Z to be urged against the first conductor 11A and the second conductor 11B.

The first resilient member 13A functions to urge the first conductor 11A into contact with the terminals TA, TB, . . . TZ at the first end of each of the plurality of cells 15A, 15B, . . . 15Z. In a like manner, the second resilient member 13B functions to urge the first conductor 11B into contact with the terminals at the second end (not shown) of each of the plurality of cells 15A, 15B, . . . 15Z.

In this embodiment, the first resilient member 13A and the second resilient member 13B are fabricated as a unitary body from silicone rubber, which is particularly effective material for use in performing the aforementioned function by extending into depressions corresponding to each of the plural protrusions, e.g. 17A, 17B, . . . 17Z, provided on the first and second conductor 11A, 11B when a compressive force is applied to the battery pack assembly 1.

Advantageously, this provides additional safety performance without compromising the ease of assembly/disassembly of the battery pack assembly 1. Moreover, the unitary nature of both the first resilient member 13A and the second resilient member 13B enable ease of fabrication, removal and/or replacement for refurbishing or recycling the components of the battery pack assembly 1 when disassembled into its constituent parts.

The fasteners 12A, 12B, . . . 12Z are reversible, and as such, removal or loosening of the fasteners 12A, 12B, . . . 12Z enables the plurality of cells 15A, 15B, . . . 15Z to be freed from the battery pack assembly 1, when in an opened or disassembled condition.

Referring now to FIGS. 2A to 2C, there is shown exploded views of a battery pack assembly 2 according to the second embodiment of the invention. Referring also to FIG. 2D, there is shown a plan view of the battery pack assembly 2. Referring also to FIG. 2E, there is shown the battery pack assembly 2 in an assembled or closed condition.

The battery pack assembly 2 is similar to that described in FIGS. 1A to 1C, and as such, like features are designated with a prime (′) and will not be described further.

In this embodiment, the first and second holding frames 20A, 20B do not have side walls. Instead, the first and second holding frames 20A, 20B each comprise a plurality of base protrusions, e.g. P1′, P2′ only, each of which correspond to a cell terminal, e.g. TA′. Additionally, there is no lid 14 present in this embodiment.

In FIGS. 2A to 2C, there are shown nuts 21A, 21B, . . . 21Z′ for securing to the fasteners 15A′, 15B′, . . . 15Z′ (bolts) to provide compressive forces to the battery pack assembly 2.

Referring now to FIGS. 3A to 3C, there is shown exploded views of a battery pack assembly 3 according to the second embodiment of the invention. Referring also to FIG. 3D, there is shown the battery pack assembly 3 in an assembled or closed condition.

The battery pack assembly 3 comprises a first outer holding frame 30A, a second outer holding frame 30B, a first conductor 31A, a second conductor 31B, a plurality of fasteners 32A, 32B, . . . 32Z, a first resilient member 33A, and a second resilient member 33B.

The features of the battery pack assembly 3 are similar and perform substantially the same functions as those shown for the battery pack assemblies 1 and 2 shown in FIGS. 1A and 2A. Only the differences will be described.

In this embodiment, the battery pack assembly 3 further comprises an intermediate holding frame 37, a third conductor 31C and a fourth conductor 31D.

The battery pack assembly 3 is configured in use to hold a first plurality of cells 35A, 35B, . . . 35Z between the first outer holding frame 30A and the intermediate holding frame 37 in a longitudinal configuration. The battery pack assembly 3 is further configured in use to hold a second plurality of cells 38A, 38B, . . . 38Z between the intermediate holding frame 37 and the second outer holding frame 30B in a longitudinal configuration.

The third conductor 31C is located between the first plurality of cells 35A, 35B, . . . 35Z and the fourth conductor 31D, and the fourth conductor 31D is located between the third conductor 31C and the intermediate holding plate 37. The intermediate holding plate 37 is located between the fourth conductor 31D and the second plurality of cells 38A, 38B, . . . 38Z.

In this embodiment, the battery pack assembly 3 is configured to hold forty-eight cells in the first plurality of cells 35A, 35B, . . . 35Z, and forty-eight cells in the second plurality of cells 38A, 38B, . . . 38Z. The cells may, for example, lithium ion batteries. For convenience only three cells are labeled for each set in FIG. 3A.

The first outer holding frame 30A further comprises slots 36A, 36B, . . . 36Z for receiving the fasteners 32A, 32B, . . . 32Z.

The second outer holding frame 30B and the intermediate holding frame 37 also comprise slots (not shown) for receiving the fasteners 32A, 32B, . . . 32Z such that each fastener, for example 32A, is inserted into the slot 36A of the first holding frame 30A and is received within a corresponding slot (not shown) in the intermediate holding frame 37 and the second outer holding frame 30B.

In use, the fasteners 32A, 32B, . . . 32Z are received in the slots 36A, 36B, . . . 36Z, and are configured using compressive forces to reversibly hold the first outer holding frame 30A, the intermediate holding frame 37, and the second outer holding frame 30B with respect to one another in a closed or assembled condition.

In the closed or assembled condition, the fasteners 32A, 32B, . . . 32Z cause terminals of the first plurality of cells 35A, 35B, . . . 35Z and the second plurality of cells 38A, 38B, . . . 38Z to be urged against the first conductor 31A and the second conductor 31B respectively.

Referring now to FIGS. 4A to 4C, there is shown exploded views of a battery pack assembly 4 according to the fourth embodiment of the invention. Referring also to FIG. 2D there is shown the battery pack assembly 4 in an assembled or closed condition.

The battery pack assembly 4 is similar to that described in FIGS. 3A to 3D, and as such, like features are designated with a prime (′) and will not be described further. Only the differences are described.

The battery pack assembly 4 comprises a first plurality of cells 35A′, 35B′, . . . 35Z′ and a second plurality of cells 38A′, 38B′, . . . 38Z′. Both the first plurality of cells 35A′, 35B′, . . . 35Z′ and a second plurality of cells 38A′, 38B′, . . . 38Z′ each comprise ninety-six cells. As such, the number of cells in the battery pack assembly of the invention may be tailored for different applications.

It will be appreciated by those skilled in the art that several variations to the aforementioned embodiments are envisaged without departing from the scope of the invention. For example, instead of bolts (and threaded holes into which the bolts are located), other fastening means which can be tightened to clamp or urge the plates towards each other may be provided.

It will also be appreciated by those skilled in the art that any number of combinations of the aforementioned features and/or those shown in the appended drawings provide clear advantages over the prior art and are therefore within the scope of the invention described herein.

1. A battery pack assembly comprising a first and second holding frame for holding a plurality of cells therebetween, a conductor for engaging the plurality of cells and having at least a first contact for engaging a first cell terminal and a second contact for engaging a second cell terminal, a resilient member being located between the conductor and one of the first holding frame or second holding frame to bear against the conductor adjacent the first contact and second contact.

2. An assembly according to claim 1, wherein the conductor comprises one or more conductive plates.

3. An assembly according to claim 2, wherein the one or more conductive plates comprise one or more protrusions for contact with one or more of the terminals of the plurality of cells.

4. An assembly according to claim 3, wherein in the closed condition, each cell terminal is in electrical contact with a protrusion on the one or more conductive plates.

5. An assembly according to claim 3, wherein in the closed condition, the resilient member extends into the one or more protrusions.

6. An assembly according to claim 1, wherein the resilient member comprises a unitary body.

7. An assembly according to claim 1, wherein the resilient member is sized to extend across a base portion of at least one of the first and/or second holding frame, to one or more internal edges and/or an inner perimeter of one of the holding frames.

8. An assembly according to claim 1, wherein the first and/or second holding frame comprises one or more locating members to provide one or more cell locating structures.

9. An assembly according to claim 8, wherein the resilient member comprises cooperating members for cooperation with the locating members of the first and/or second holding frames.

10. An assembly according to claim 8, wherein the conductor comprises cooperating members for cooperation with the locating members of the first and/or second holding frames.

11. An assembly according to claim 1, wherein the resilient member comprises an elastomeric material.

12. An assembly according to claim 1, wherein at least one of the holding frames comprises a base portion and/or a side wall.

13. (canceled)

14. An assembly according to claim 1, wherein at least one holding frame comprises base protrusions extending perpendicularly from the base.

15. An assembly according to claim 14, wherein the walls of the one or more base protrusions comprise a plurality of concave arcuate sections, the radius of curvature generally equal to the radius of one of the plurality of cells, so that a cell is at least partially received by the concave arcuate section.

16. An assembly according to claim 1, further comprising a third holding frame.

17. An assembly according to claim 1, further comprising a fastener, to releasable hold the assembly together.

18. An assembly according to claim 1, wherein one of the frames is or provides an access lid, which is openable or removable to provide access to the cells.

19. An assembly according to claim 1, wherein at least one holding frame comprises one or more terminals for connection to an external electrical circuit.

20.-21. (canceled)

22. As assembly according to claim 1, further comprising one or more frictionally retained conduction breakers.

23.-24. (canceled)

25. A method for assembling a battery pack assembly, the method comprising providing a first holding frame and a second holding frame, locating a plurality of cells between the first holding frame and the second holding frame, locating a conductor between each of the first and second holding frames and the plurality of cells for connection to at least two of the plurality of cells, locating a resilient member between at least part of the conductor or conductor and one or both of the first or second holding frame, and fastening at least one fastener to reversibly hold the first and second holding frames with respect to one another in a closed condition such that with the first and second holding frames in the closed condition the conductor or conductor is urged into contact by the resilient member with said cell terminals.
